(19) United States
(12) Patent Application Publication
(10) Pub. No.: US 2024/0234045 A1
(43) Pub. Date: Jul. 11, 2024

(54) Specialized Key Switches for Electronic Key Caps

(71) Applicant: HEWLETT-PACKARD DEVELOPMENT COMPANY, L.P., Spring, TX (US)

(72) Inventors: Huaichung Hsu, Fountain Valley, CA (US); Wei-min Liang, Fountain Valley, CA (US)

(21) Appl. No.: 18/563,826

(22) PCT Filed: May 28, 2021
(86) PCT No.: PCT/US2021/034792

§ 371 Date: Nov. 22, 2023

Related U.S. Application Data
(63) Continuation of application No. 17/331,208, filed on May 26, 2021, now abandoned.

(51) Int. Cl. H01H 13/04; H01H 13/14

(52) U.S. Cl. CPC H01H 13/04; H01H 13/14

(57) ABSTRACT

This application is directed to system, devices, and methods of keyboard key switches that facilitate electrical connections to specialized keycaps. In some embodiments, a serial connection (e.g., USB or any serial protocol) can be created and maintained between a key switch of the inventive subject matter and a specialized keycap that couples with a top portion of the key switch's plunger. Key switches of the inventive subject matter incorporate spring probes to create electrical connections between a printed circuit board disposed below the key switches and the top portions of the key switches' plungers. Thus, different regions of a key switch's plunger can feature different conductive regions, which facilitates creating electrical connections between a PCB and a specialized keycap.

### FIELD OF THE INVENTION

The field of the invention is keyboard key switches.

### BACKGROUND

The background description includes information that may be useful in understanding the present invention. It is not an admission that any of the information provided in this application is prior art or relevant to the presently claimed invention, or that any publication specifically or implicitly referenced is prior art.

Early keyboards were known, in part, for the sound the keys made when pressed. The recognizable clicking was the result of each key being configured as an actual physical switch that, when actuated, resulted in creating an electrical signal or closing/opening a circuit that a computer interpreted as a key press. Now, many custom keyboards are built with mechanical key switches or key switches designed to imitate the feel of a mechanical key switch. Enthusiasm for custom keyboards has grown dramatically in recent years, culminating in an entirely new industry growing up around custom keyboards that can be made using custom keycaps. Key caps can fit onto a variety of key switches having standardized connection components atop a plunger portion, where the standardized connection component is generally made as a part of the plunger.

But current technologies limit customizability and functionality to cosmetic changes brought about by switching out the purely mechanical keycaps. Current technologies fail to take advantage of improved customizability that can result from key switches that can accommodate specialized electronic keycaps. Moreover, existing push buttons that do feature screens are not built to expand into entire keyboards using existing standards for, e.g., mechanical keyboard key switches.

For example, U.S. Pat. No. 8,080,751 is directed to push button switches having small displays. This patent fails to contemplate features that facilitate hobbyists to create entire custom mechanical keyboards, such as standardized couplings for existing keycaps as well as a standard form factor for keyboard key switches.

There exists a need in the art for improved keyboard key switches that make it possible for electronic keycaps to be coupled with those key switches using, e.g., serial communication protocols to facilitate expandable, reconfigurable keyboards.

This and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

### SUMMARY OF THE INVENTION

The present invention provides apparatuses, systems, and methods directed to specialized key switches that facilitate the creation and use of specialized electronic keycaps.

In one aspect of the inventive subject matter, a keyboard key switch is contemplated, the key switch comprising: an upper casing having a space for a plunger; a lower casing coupled with the upper casing to form an interior space; the plunger disposed in the space; the plunger having a protrusion on a top portion (e.g., a cross-shaped protrusion); the protrusion having a first conductive region, a second conductive region, a third conductive region, and a fourth conductive region; where the first conductive region, the second conductive region, the third conductive region, and the fourth conductive region each extend to a bottom surface of the plunger; a first spring probe, a second spring probe, a third spring probe, and a fourth spring probe, each disposed at least partially within the interior space; where a bottom portion of the first spring probe, a bottom portion the second spring probe, a bottom portion the third spring probe, and a bottom portion the fourth spring probe extend through a bottom surface of the lower casing; and where a top portion of the first spring probe, a top portion the second spring probe, a top portion the third spring probe, and a top portion the fourth spring probe each contact the first conductive region, the second conductive region, the third conductive region, and the fourth conductive region, respectively, on the bottom surface of the plunger.

In some embodiments, the plunger comprises a shaft and the lower casing comprises a complementary shaft receiver. In some embodiments, the key switch also includes a cantilevered spring disposed within the interior space, wherein the cantilevered spring comprises a curved portion that interacts with a protrusion disposed on a side of the plunger. In some embodiments, the first region is disposed on a first member of the cross-shaped protrusion, the second region is disposed on a second member of the cross-shaped protrusion, the third region is disposed on a third member of the cross-shaped protrusion, and the fourth region is disposed on a fourth member of the cross-shaped protrusion.

In another aspect of the inventive subject matter, a keyboard key switch is contemplated, the key switch comprising: an upper casing having a space for a plunger; a lower casing coupled with the upper casing to form an interior space; the plunger disposed in the space; the plunger having a protrusion on a top portion (e.g., a cross-shaped protrusion); the protrusion having a first conductive region and a second conductive region; where the first conductive region and the second conductive region extend to a bottom surface of the plunger; a first spring probe and a second spring probe each disposed at least partially within the interior space; where a bottom portion of the first spring probe and a bottom portion the second spring probe extend through a bottom surface of the lower casing; and where a top portion of the first spring probe and a top portion the second spring probe each contact the first conductive region and the second conductive region, respectively, on the bottom surface of the plunger.

In some embodiments, the plunger includes a shaft, and the lower casing comprises a complementary shaft receiver. The key switch can additionally include a cantilevered spring disposed within the interior space, wherein the cantilevered spring comprises a curved portion that interacts with a protrusion disposed on a side of the plunger. In some embodiments, the first region is disposed on a first member of the cross-shaped protrusion and the second region is disposed on a second member of the cross-shaped protrusion.

In another aspect of the inventive subject matter, a keyboard key switch is contemplated, the key switch comprising: an upper casing having a space for a plunger; a lower casing coupled with the upper casing; the plunger disposed in the space; the plunger having a protrusion on a top portion; and the protrusion having a first conductive region, a second conductive region, a third conductive region, and a fourth conductive region.

In some embodiments, the first conductive region, the second conductive region, the third conductive region, and the fourth conductive region extend to a bottom portion of the plunger.

One should appreciate that the disclosed subject matter provides many advantageous technical effects including giving key switches the ability to accommodate specialized electronic key caps that introduce new functionalities and customizability.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an isometric view of a key switch of the inventive subject matter.

FIG. 2 is a top view thereof.

FIG. 3 is a side view thereof.

FIG. 4 is a bottom view thereof.

FIG. 5 is a cutaway view thereof.

FIG. 6 is a view showing internal components thereof.

FIG. 7 shows spring probes of the inventive subject matter.

FIG. 8 shows examples of custom keycaps that can be used with embodiments of the inventive subject matter.

FIG. 9 is a schematic showing a key switch of the inventive subject matter coupled with a printed circuit board.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

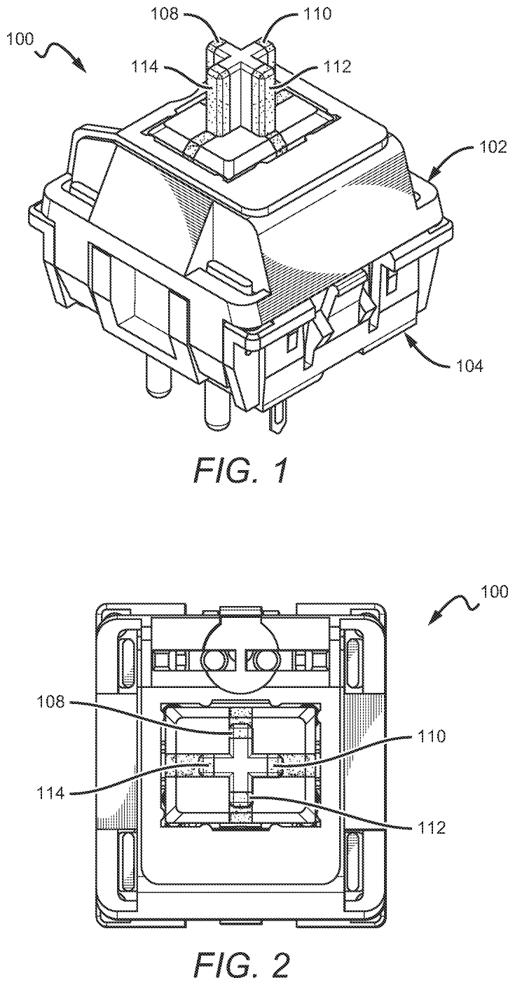

FIG. 1 shows an isometric view of a key switch 100 of the inventive subject matter and FIG. 2 shows a top view. Key switch 100 features an upper casing 102, a lower casing 104, and a plunger 106. Plunger 106 includes several different regions, each corresponding to a different spring probe disposed below plunger 106. In some embodiments, plungers of the inventive subject matter facilitate a serial connection (e.g., USB) between a PCB disposed below key switch 100 and a keycap coupled with plunger 106. First region 108 can correspond to a VBUS (or V_{CC}) line, second region 110 can correspond to signal pin 1 (e.g., D+), third region 112 can correspond to GND, and fourth region 114 can correspond to signal pin 2 (e.g., D−).

These regions (108, 110, 112, and 114) can be configured to conform to a wide variety of different communication protocols, including those that currently exist (e.g., USB and its many variations) as well as protocols that are developed in the future. All now-known USB and serial communication protocols are incorporated herein by reference. Regions 108, 110, 112, and 114 can be made from a conductive material with areas between regions being made from an insulating material (e.g., plastic). Regions 108, 110, 112, and 114 in embodiments of the inventive subject matter can comprise one or more conductive materials, including copper, gold, and various conductive alloys.

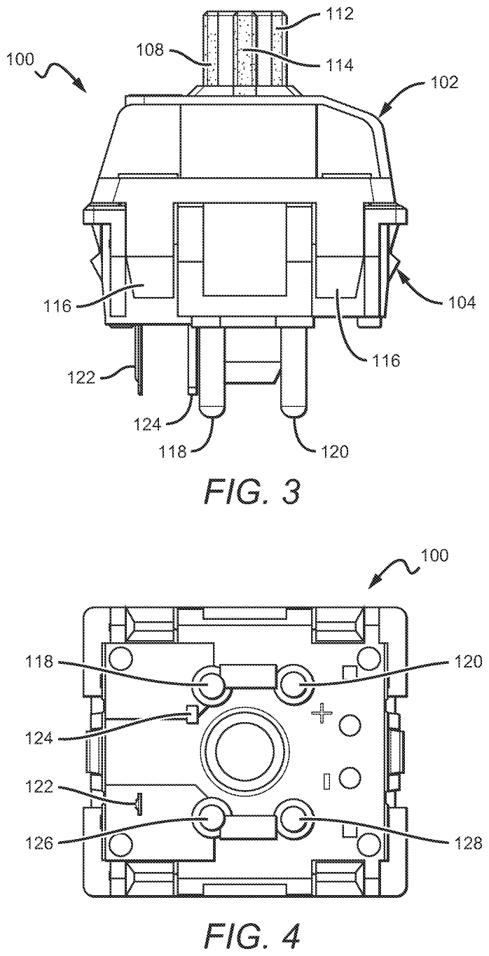

FIG. 3 shows a side of key switch 100. It shows that upper casing 102 includes coupling arms 116 that snap onto lower casing 102. Protruding out the bottom of lower casing 102, spring probes 118 and 120 as well as a first protrusion 122 and a second protrusion 124. First protrusion 122 and second protrusion 124 are extensions of a cantilever spring mechanism, discussed in more detail below. Spring probes 118 and 120 are more easily visible in FIG. 4, which shows spring probes 126 and 128 as well. Spring probe 120 couples with first region 108 (VBUS), spring probe 128 couples with third region 112 (signal pin 2), spring probe 118 couples with second region 110 (signal pin 1), and spring probe 126 couples with fourth region 114 (GND). It is contemplated that spring probes 118, 120, 168, and 128 can be used for any type of data transmission protocol. The example above relates to USB, though the spring probes can be changed depending on the protocol implemented.

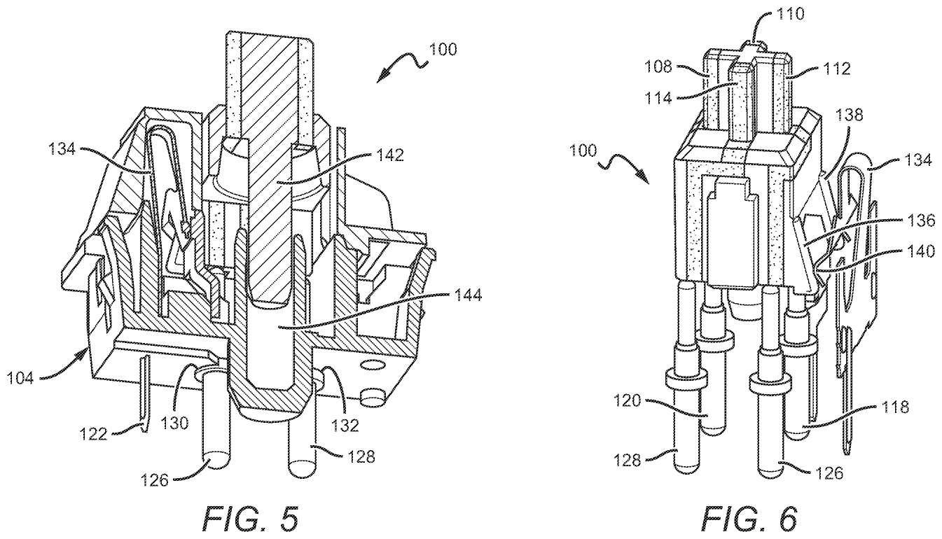

Each spring probe (118, 120, 126, and 128) protrudes through a corresponding hole in lower casing 102. FIG. 5, which is a cutaway view of key switch 100, shows spring probe 126 and spring probe 128. Spring probe 126 passes through first hole 130 in lower casing 102 and spring probe 128 passes through second hole 132 in lower casing 102. Although not picture because of the cutaway view, spring probes 118 and 120 similarly protrude through a third and fourth hole in the lower casing 102. By protruding down through lower casing 102, spring probes can contact, e.g., a printed circuit board (PCB) having coupling points for each of the spring probes. That PCB can facilitate serial connections, as described above, for a plurality of key switches (e.g., an entire keyboard).

FIG. 5 also shows internal aspects of key switch 100, including cantilevered spring 134. Cantilevered spring 134 interacts with plunger 106 to create resistance to a key press. In other words, when a user actuates key switch 100 by pressing a keycap (not pictured) that couples with plunger 106, plunger 106 moves downward and interacts with a surface of cantilevered spring 134. Cantilevered spring 134 provides resistance to the user's finger and, depending on how cantilevered spring 134 is configured, it can provide different force versus displacement curves.

FIG. 5 also shows internal structures of plunger 106. Plunger 106 features a shaft 142, which is sized and dimensioned to fit within shaft receiver 144. The combination of shaft 142 and shaft receiver 144 results in plunger 106 being able to translate up and down without unwanted rotation.

FIG. 6 shows key switch 100 with both upper and lower casings hidden. This view shows better how cantilevered spring 134 interacts with plunger 106. Plunger 106 features a first plunger protrusion 136 and a second plunger protrusion 138, both of which interact with symmetrically disposed portions of cantilevered spring 134. Cantilevered spring 134 interacts with first plunger protrusion 136 and second protrusions 138 by a first curved portion 140 and a second curved portion (abuts second plunger protrusion 138), respectively. Second curved portion, the view of which is obstructed in FIG. 6, is symmetrical to first curved portion 140.

First curved portion 140 and second curved portion apply reaction forces (e.g., a reaction force to spring compression/bending) to first plunger protrusion 136 and second plunger protrusion 138, and as plunger 106 is depressed, the curved portions slide along the protrusions, which are formed as linearly sloped surfaces, though other shaped surfaces can be implemented to create different tactility upon depressing plunger 106. Spring probes 118, 120, 126, and 128 also contribute to force response of key switch 100 upon depressing plunger 106. Because plunger 106 is pressed down against the spring probes, the springs within the spring probes

FIG. 6 also shows how spring probes are coupled with the conductive regions at the top of plunger 106. For example, spring probe 128 contacts fourth region 114 at a bottom edge of plunger 106, and spring probe 126 contacts third region 112 at the bottom edge of plunger 106. Spring probes 120 and 118 similarly couple with first region 108 and second region 110, respectively, via the bottom of plunger 106.

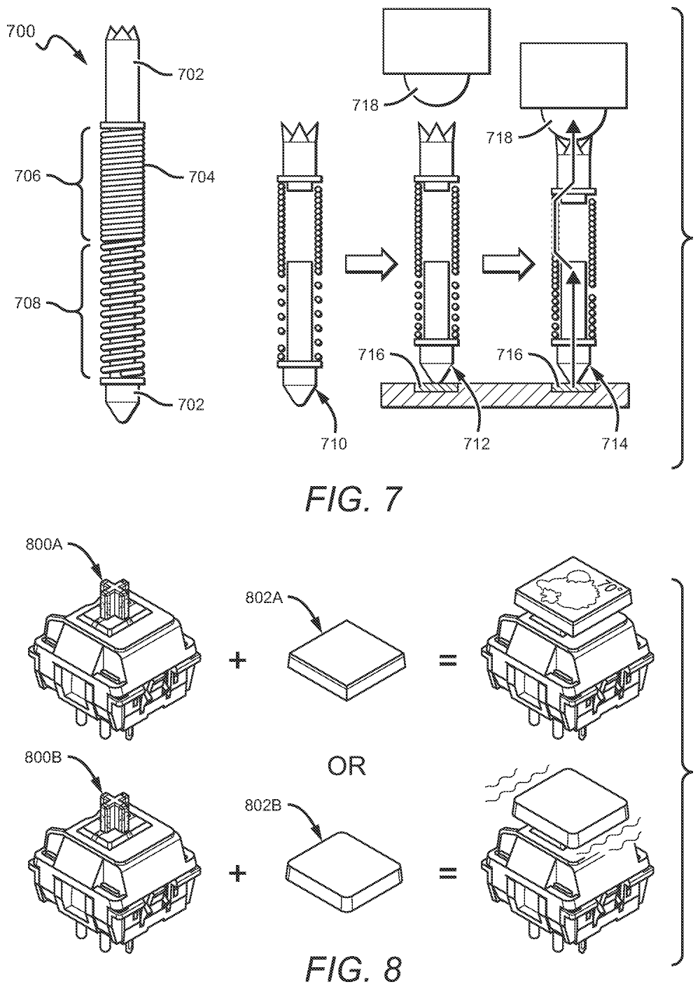

FIG. 7 shows how spring probes of the inventive subject matter create and maintain an electrical connection between two different points. Spring probe 700 comprises a probe plunger 702 and a spring 704. Probe plunger 702 can be configured, e.g., as a telescoping mechanism whereby spring 704 biases probe plunger 702 to remain in a fully extended configuration. As shown in FIG. 7, spring 704 can be formed as a coil spring and it can include two different sections, a fixed section 706 and a stroke section 708. Fixed section 706 can be formed, e.g., such that the springs coils are in contact with one another, preventing fixed section from allowing for any displacement by compression (e.g., it is fully compressed). Stroke section 708 can be formed with spaces between coils to allow for probe plunger 702 to compress, resulting in a reaction force from spring 704. In some embodiments, probe plunger 702 includes a conductive material that allow for current or other electrical signals to pass from one end probe plunger 702 to the other. In some embodiments, spring 704 is also made to include a conductive material to improve an electrical connection between the ends of probe plunger 702.

FIG. 7 also shows spring probe 700 in three different states, free state 710, set state 712, and contact state 714. In free state 710, spring probe 700 is depicted fully extended and not in contact with any conductive elements. In set state 712, spring probe 700 is depicted such that a bottom portion is in contact with conductive pad 716 and a top portion of spring probe 700 is shown near conductive lead 718. Conductive lead 718 models a conductive portion of a plunger of the inventive subject matter, where that conductive portion is electrically coupled with one of the plurality of regions on the top of the plunger. Finally, in contact state 714, spring probe 700 is shown in contact with both conductive pad 716 as well as with conductive lead 718. An electrical connection between conductive pad 716 and conductive lead 718 can be maintained by spring probe 700 even when spring probe 700 is pushed into a compressed state (e.g., the top is pressed toward the bottom). Conductive lead 718 can be, e.g., an area on a bottom surface of a plunger of the inventive subject matter, as shown in FIG. 6.

Although it is described as a pad, conductive pad 716 can be, e.g., a through hole into which at least a portion of spring probe 700 fits into to create an electrical coupling between the two components. In some embodiments, spring probe 700 can be soldered to conductive pad 716. In some embodiments, spring probe 700 can be soldered to conductive lead 718. It is contemplated that any combination of pressure-based contact or solder-based contact can be implemented on either end of spring probes of the inventive subject matter.

Key switches of the inventive subject matter facilitate coupling with keycaps that are configured to perform a variety of different functions. FIG. 8 shows two different examples of keycaps configured to perform different functions that can be enabled by, e.g., a serial connection between keycap and key switch. Key switch 800A is shown combined with keycap 802A to create a key that has a small display screen disposed thereon. A keyboard comprising all or some subset of keys having display screens can, e.g., be configured to display different alphabets, emojis, different keyboard configurations (DVORAK, QWERTY, etc.), and so on. Key switch 800B is shown with keycap 802B, and those components combine to create a key that can provide haptic (e.g., vibration) and sound feedback. Keys that provide haptic and sound feedback can be configured in a keyboard to create, e.g., a mechanical keyboard that vibrates or makes a sound upon actuating one or more keys.

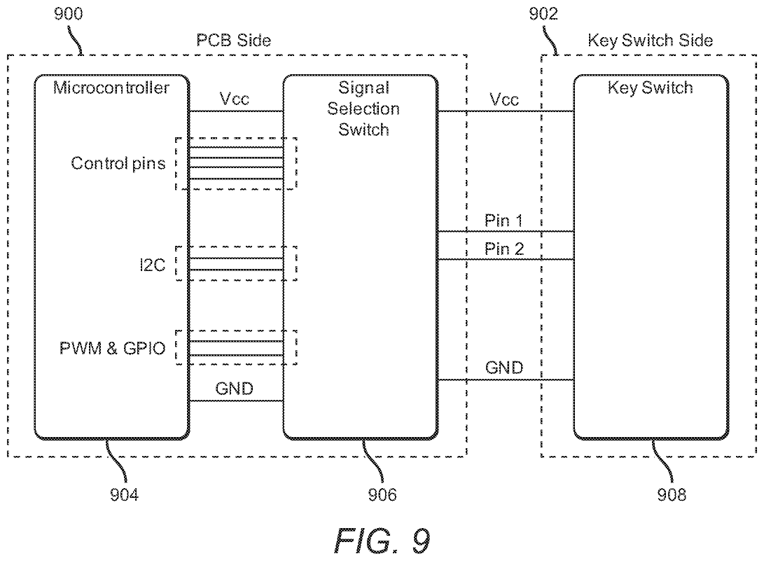

FIG. 9 shows a schematic of how a key switch of the inventive subject matter can be coupled with a PCB. This configuration can be expanded to create an entire keyboard. There are two sides shown schematically: the PCB side 900 and the key switch side 902. PCB side 900 includes a microcontroller 904 and a signal selection switch 906, and key switch side 902 features a key switch 908 of the inventive subject matter. In some embodiments, microcontroller 904 can be configured to couple one-to-one with signal selection switch 906, which can in turn couple one-to-one with key switch 908. In some embodiments, microcontroller 904 can be configured to couple with a plurality of signal selection switches, and each signal selection switch can in turn be configured to couple with a plurality of key switches. In some embodiments, though, each signal selection switch couples with a single key switch.

As shown in FIG. 9, microcontroller 904 couples with signal selection switch 906 via V_{CC} (voltage common collector), control pins, I2C lines (I2C is a synchronous, multi-master, multi-slave, packet switched, single-ended, serial communication bus), and PWM & GPIO lines (pulse-width modulation and general-purpose input and output), as well as a ground line. Although each of these is modeled as having a particular number of lines/pines forming the coupling between the microcontroller and the signal selection switch, it should be understood that the number of lines/pins drawn does not necessarily correlate to the number of lines/pins required in a particular implementation of the inventive subject matter.

PCB side 900 then couples with key switch side 902 by, e.g., four lines: V_{CC}, signal pin 1, signal pin 2, and GND (ground). This configuration, as discussed above, can be expanded to create an entire keyboard using key switches of the inventive subject matter. In the world of mechanical keyboards, embodiments of the inventive subject matter will enable hobbyists, enthusiasts, and even ordinary consumers to create more capable keyboards having features that were previously impossible to create.

Thus, specific systems, devices, and methods directed to keyboard key switches that facilitate electronically controlled keycaps have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A keyboard key switch comprising:
an upper casing having a space for a plunger;
a lower casing coupled with the upper casing to form an interior space;
the plunger disposed in the space;
the plunger having a protrusion on a top portion;
the protrusion having a first conductive region, a second conductive region, a third conductive region, and a fourth conductive region;
wherein the first conductive region, the second conductive region, the third conductive region, and the fourth conductive region each extend to a bottom surface of the plunger;
a first spring probe, a second spring probe, a third spring probe, and a fourth spring probe, each disposed at least partially within the interior space;
wherein a bottom portion of the first spring probe, a bottom portion the second spring probe, a bottom portion the third spring probe, and a bottom portion the fourth spring probe extend through a bottom surface of the lower casing; and
wherein a top portion of the first spring probe, a top portion the second spring probe, a top portion the third spring probe, and a top portion the fourth spring probe each contact the first conductive region, the second conductive region, the third conductive region, and the fourth conductive region, respectively, on the bottom surface of the plunger.

2. The keyboard key switch of claim 1, wherein the plunger comprises a shaft and the lower casing comprises a complementary shaft receiver.

3. The keyboard key switch of claim 1, further comprising a cantilevered spring disposed within the interior space, wherein the cantilevered spring comprises a curved portion that interacts with a protrusion disposed on a side of the plunger.

4. The keyboard key switch of claim 1, wherein the protrusion is cross-shaped protrusion.

5. The keyboard key switch of claim 4, wherein the first region is disposed on a first member of the cross-shaped protrusion, the second region is disposed on a second member of the cross-shaped protrusion, the third region is disposed on a third member of the cross-shaped protrusion, and the fourth region is disposed on a fourth member of the cross-shaped protrusion.

6. A keyboard key switch comprising:
an upper casing having a space for a plunger;
a lower casing coupled with the upper casing to form an interior space;
the plunger disposed in the space;
the plunger having a protrusion on a top portion;
the protrusion having a first conductive region and a second conductive region;
wherein the first conductive region and the second conductive region extend to a bottom surface of the plunger;
a first spring probe and a second spring probe each disposed at least partially within the interior space;
wherein a bottom portion of the first spring probe and a bottom portion the second spring probe extend through a bottom surface of the lower casing; and
wherein a top portion of the first spring probe and a top portion the second spring probe each contact the first conductive region and the second conductive region, respectively, on the bottom surface of the plunger.

7. The keyboard key switch of claim 6, wherein the plunger comprises a shaft and the lower casing comprises a complementary shaft receiver.

8. The keyboard key switch of claim 6, further comprising a cantilevered spring disposed within the interior space, wherein the cantilevered spring comprises a curved portion that interacts with a protrusion disposed on a side of the plunger.

9. The keyboard key switch of claim 6, wherein the protrusion is cross-shaped protrusion.

10. The keyboard key switch of claim 9, wherein the first region is disposed on a first member of the cross-shaped protrusion and the second region is disposed on a second member of the cross-shaped protrusion.

11. A keyboard key switch comprising:
an upper casing having a space for a plunger;
a lower casing coupled with the upper casing;
the plunger disposed in the space;
the plunger having a protrusion on a top portion; and
the protrusion having a first conductive region, a second conductive region, a third conductive region, and a fourth conductive region.

12. The keyboard key switch of claim 11, wherein the first conductive region, the second conductive region, the third conductive region, and the fourth conductive region extend to a bottom portion of the plunger.
